(19) United States
(12) Patent Application Publication
(10) Pub. No.: US 2025/0302688 A1
(43) Pub. Date: Oct. 2, 2025

(54) SYSTEM AND METHOD FOR FINGER ACTUATION

(71) Applicant: Brad Wu, Chandler, AZ (US)

(72) Inventor: Brad Wu, Chandler, AZ (US)

(21) Appl. No.: 19/098,106

(22) Filed: Apr. 2, 2025

Related U.S. Application Data
(60) Provisional application No. 63/573,321, filed on Apr. 2, 2024.

(51) Int. Cl. A61H 1/02

(52) U.S. Cl. CPC A61H 1/0288; A61H 2201/1207; A61H 2201/1638; A61H 2201/1676; A61H 2201/5007; A61H 2201/5061; A61H 2201/5084

(57) ABSTRACT

A finger actuation structure for assisting with finger movement is disclosed. The device includes one or more finger rings designed to partially envelop at least one finger of a user. These rings are connected to a series of articulated linkages, which are in turn controlled by a plurality of actuators. A control unit receives input signals of desired finger movement and generates control signals to operate the actuators. The device also includes a number of joints that connect adjacent linkages and allow relative movement between them. The finger rings may include sensors such as force sensitive resistors or inertial measurement units to detect location, motion, force, and position of the user's finger. The device may further include a computer vision coupled to the control unit. A method for controlling the device includes inputting a user command, choosing between rehab training or practicing, and activating at least one actuator.

### CROSS REFERENCE TO RELATED APPLICATION

This application claims benefit from currently pending U.S. Provisional Application No. 63/573,321 titled “A hybrid finger exoskeleton rehabilitation system (FERS) for stroke patients with motor impairment” and having a filing date of Apr. 2, 2024 all of which is incorporated by reference herein.

### FIELD OF THE INVENTION

The present invention relates to a finger actuation structure designed for use with at least one finger and even more specifically a device and method for controlling a rehabilitation device.

### BACKGROUND OF THE INVENTION

Stroke is a leading cause of long-term disability worldwide, often resulting in motor impairments that significantly affect a patient's quality of life. A stroke can cause a loss of cerebral function in individuals, resulting in deficits across multiple areas including motor impairment. Motor impairment post-stroke can manifest as weakness, spasticity, and loss of coordination in the affected limb, particularly the hand and fingers. These deficits can hinder activities of daily living and limit independence. A variety of treatment and therapy approaches have been utilized to address strokes and symptoms associated with motor impairment. These include professional Physical Therapy (PT) and Occupational Therapy (OT), which focus on improving functional mobility. These traditional rehabilitation methods for stroke patients often involve repetitive exercises to help the individual regain function of their hand and fingers. While these interventions can be beneficial, they may not always target specific hand and finger movements effectively, leading to suboptimal outcomes.

As a result, compact and motorized robotic devices, like hand or finger actuation structure have been developed to help stroke patient rehabilitation. These finger actuation structures can exert external joint torque or force on the fingers to aid movement. Consistent repetition of movements can provide neuromuscular training and re-education, promoting self-rehabilitation progress. Moreover, hand and finger actuation structure can assist in performing essential daily tasks such as grasping, holding, typing, lifting, and more, while also facilitating finger movement. While the motorized hand and finger actuation structure show great potential for rehabilitation, most existing devices primarily focus on improving overall finger movement and strength. Only a few devices have adequately addressed the specific training requirements related to precision in finger movements, fine motor coordination, and isolated finger movements. Existing devices for hand rehabilitation may have limitations, including bulkiness, lack of adaptability to individual patient needs, and limited range of motion.

In response to these challenges, the development of a new finger actuation structure specifically tailored for stroke patients with motor impairment has gained traction. The new finger actuation structure aims to address the shortcomings of traditional rehabilitation methods and existing technologies by offering a versatile, adaptable, and user-friendly solution. The design concept of new finger actuation structure incorporates elements of both passive and active devices, providing support and assistance while allowing for natural finger movements. By combining mechanical support with sensorimotor feedback, new finger actuation structure facilitates neuroplasticity and motor relearning in stroke patients, promoting recovery and functional improvement.

Fine motor coordination involves the harmonious functioning of muscles, bones, and nerves to produce small, precise movements. Precision on fingers refers to the fingers' ability to achieve a specific goal, and it needs the precise movement of each finger joint. Isolated Finger Movement entails the ability to move each finger individually. The absence of training in these areas can significantly prolong rehabilitation time and strengthening of the user's finger joints.

Therefore, there is a need for a hybrid rehabilitation system that combines mechanical support with sensorimotor feedback, the new finger actuation structure facilitates neuroplasticity and motor relearning system in stroke patients that will promote recovery and functional improvement.

### BRIEF SUMMARY OF THE INVENTION

The present invention relates to a new finger actuation structure designed for use with at least one finger. The structure comprises one or more finger rings, a plurality of actuators, a control unit, and a plurality of joints. The finger rings are configured to partially envelop at least one finger of a user. These rings are coupled to a plurality of articulated linkages, creating a structure that mimics the natural movement and flexibility of a human finger. It is an object of the invention to accurately control force on each joint and phalanx.

Each linkage is operatively coupled to an actuator, which is responsible for driving the movement of the linkages. The linkages are connected by a series of joints, each of which allows relative movement between adjacent linkages. This design ensures that the device can accurately replicate the complex movements of a human finger. The control unit of the device is configured to receive input signals of a desired finger movement. These signals can be generated by a variety of sources, such as a user interface or a sensor embedded in the device. Upon receiving these signals, the control unit generates control signals that are used to control the actuators. By adjusting the control signals, the control unit can precisely control the movement of the finger rings and, by extension, the user's finger.

The actuators can be servo motors. The articulated linkages can also be of various types, including servo linkages and relieve linkages. In one embodiment, the relieve linkage is a z-shaped component made of a flexible material. This design allows the linkage to flex and bend as needed, providing additional flexibility to the device. The device also includes a feedback loop that connects the sensors to the control unit. This feedback loop allows the control unit to continuously adjust the control signals based on the sensor signals, ensuring that the device can achieve the desired finger movement. This feature is particularly useful in a rehabilitation setting, where the user's finger may not have full range of motion or strength.

It is an object of the invention to implement flexion/extension degrees of freedom (DOFs) on each finger for each phalanx, and the thumb for each phalanx, abduction/adduction DOFs on the thumb and opposition DOF.

It is another object of the invention to provide a grasping or pushpin force on the finger of more than 10N.

It is another object of the invention to minimize the size of the device.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the “special” definition of that term and explain how it differs from the plain and ordinary meaning. Absent such clear statements of intent to apply a “special” definition, it is the inventors' intent and desire that the simple, plain and ordinary meaning to the terms be applied to the interpretation of the specification and claims. Aspects and applications of the invention presented here are described below in the drawings and detailed description of the invention.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for, and will also recite the word “function” (i.e., will state “means for performing the function of . . . ”), without also reciting in such phrases any structure, material or act in support of the function. Thus, even when the claims recite a “means for performing the function of . . . ” or “step for performing the function of . . . ,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

### BRIEF DESCRIPTION OF THE DRAWINGS

A more complete understanding of the present invention may be derived by referring to the detailed description when considered in connection with the following illustrative figures. In the figures, like reference numbers refer to like elements or acts throughout the figures.

FIG. 1 depicts an isometric view of the finger actuation structure in accordance to one or more embodiments;

FIG. 2 depicts an isometric view of index finger structure in accordance to one or

more embodiments;

FIG. 3 depicts an isometric view of thumb structure in accordance to one or more embodiments;

FIG. 4 depicts an flow diagram of the finger actuation structure in accordance to one or more embodiments;

FIG. 5 depicts an overall view of the finger actuation structure in accordance to one or more embodiments;

FIG. 6 depicts a diagram of an index finger positions in accordance to one or more embodiments;

FIG. 7 depicts a set of equations for the index finger positions of FIG. 6 in accordance to one or more embodiments;

FIG. 8 depicts a diagram of a thumb positions in accordance to one or more embodiments;

FIG. 9 depicts a set of equations for the thumb positions of FIG. 8 in accordance to one or more embodiments;

FIG. 10 depicts a set of equations for the index finger inverse kinematics in accordance to one or more embodiments;

FIG. 11 depicts a set of equations for the thumb inverse kinematics in accordance to one or more embodiments;

FIG. 12 depicts an artificial intelligence recognition control flow chart for the system in accordance to one or more embodiments;

FIG. 13 depicts a computer vision control with machine learning flow chart in accordance to one or more embodiments; and

FIG. 14 depicts a control process flow diagram for the rehabilitation system in accordance to one or more embodiments.

Elements and acts in the figures are illustrated for simplicity and have not necessarily been rendered according to any particular sequence or embodiment.

### DETAILED DESCRIPTION

In the following description, and for the purposes of explanation, numerous specific details are set forth to provide a thorough understanding of the various aspects of the invention. It will be understood, however, by those skilled in the relevant arts, that the present invention may be practiced without these specific details. In other instances, known structures and devices are shown or discussed more generally to avoid obscuring the invention. In many cases, a description of the operation is sufficient to enable one to implement the various forms of the invention, particularly when the operation is to be implemented in software. It should be noted that there are many different and alternative configurations, devices, and technologies to which the disclosed inventions may be applied. The full scope of the inventions is not limited to the examples that are described below.

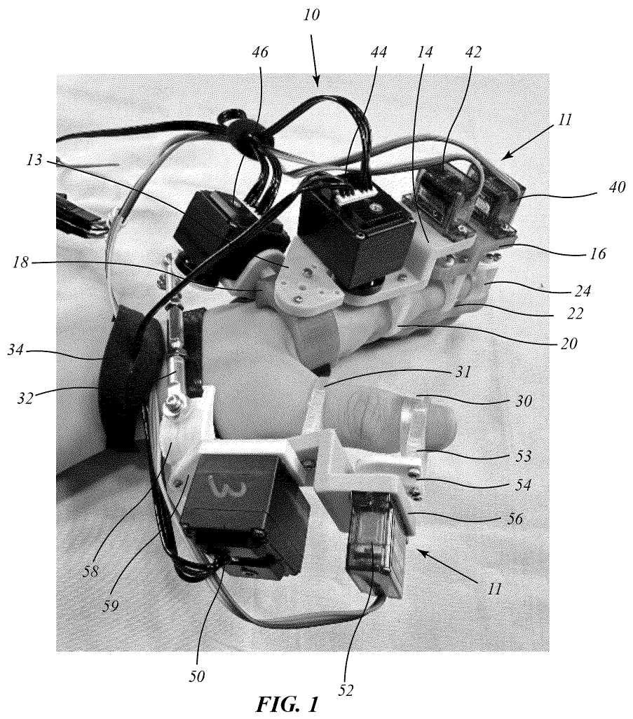

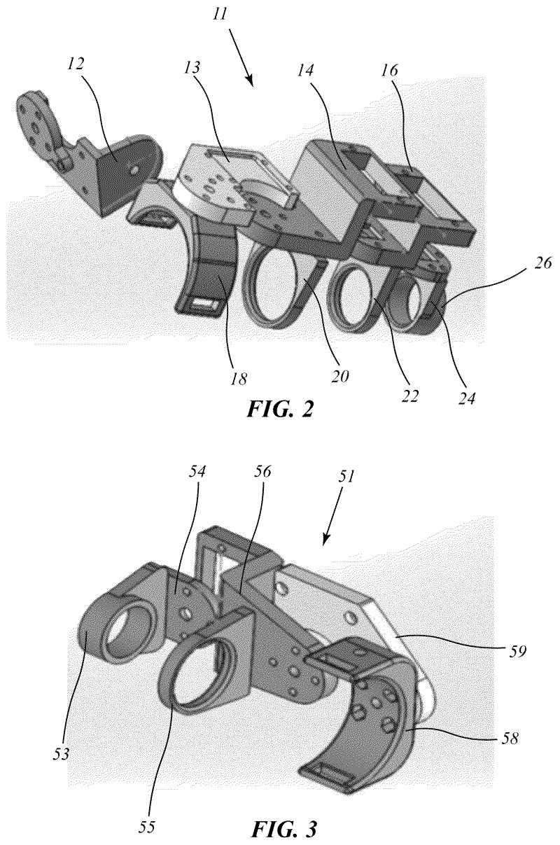

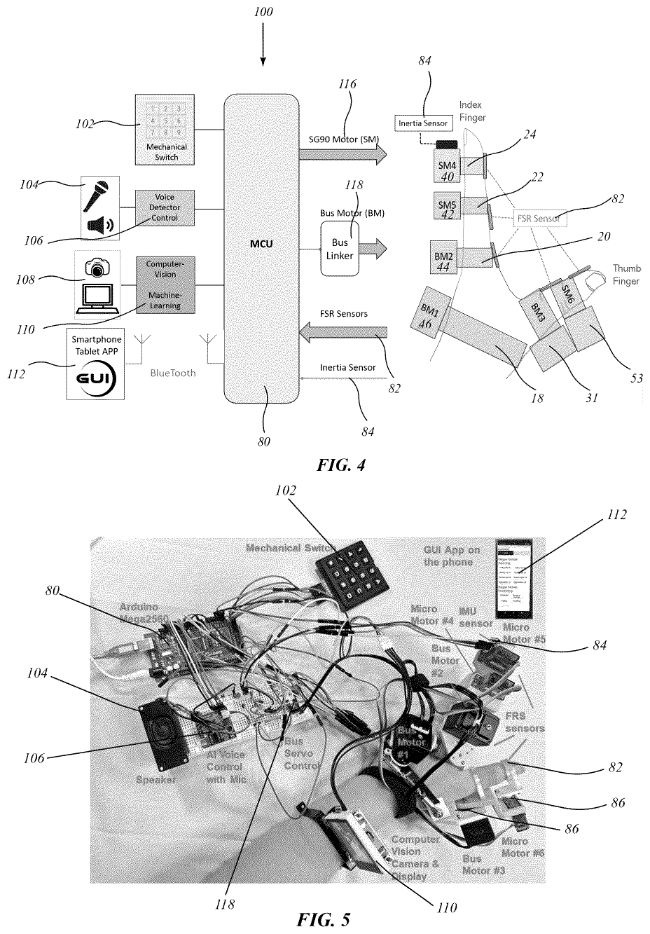

Referring initially to FIGS. 1-5, a finger actuation structure for use with at least one finger by a user shown generally at 10. Each of these components plays a crucial role in the operation of the system, and their interplay allows for the precise and controlled movement of the user's finger(s). For this application a thumb can be included as one of the fingers.

The finger actuation structure 10 can be one or more sub-structures including a finger sub-structure 11 and a thumb sub-structure 51. The finger sub-structure 11 and the thumb sub-structure 51 can have one or more finger rings which can be configured to envelop partially at least one finger of a user, wherein the one or more finger rings can be coupled to a plurality of articulated linkages. The one or more finger rings can be on the user's thumb and at least one of the user's index finger, middle finger, ring finger and pinky finger collectively referred to as the user's finger. The one or more finger rings for the user's thumb can be a thumb tip ring 58 and a thumb base ring 55 wherein the thumb tip ring and thumb base ring can partially or fully surround the user's thumb. The thumb tip ring 58 and thumb base ring 55 be coupled to a plurality of articulated linkages wherein the thumb tip ring can be coupled to a thumb tip articulated linkage 54 and the thumb base ring can be coupled to a thumb base articulated linkage 56 which can be rotatably coupled to the thumb tip articulated linkage. The thumb tip articulated linkage 54 and the thumb base articulated linkage 56 can be made from such as, for example, flexible plastic, silicone, steel, aluminum, or any combination thereof. The thumb tip articulated linkage 54 and the thumb base articulated linkage 56 can be coupled together by at least one pivot joint that allows the articulating linkages to freely move in at least one degree of freedom.

In embodiments, the one or more finger rings can further comprise one or more rings for the user's finger that can fully or partially capture each phalanx. Each ring can be coupled to the at least one articulating linkages allowing each finger joint to be bent. The finger rings can be a base ring 18, a first ring 20, a second ring 22 and a third ring 24 wherein the first ring can partially or fully surrounds the user's first phalanx, the second ring can partially or fully surround the user's second phalanx, the third ring can partially or fully surround the user's third phalanx, and the base ring 18 can partially or fully surround the base of the finger at where the finger meets the hand. The finger rings can be coupled to a plurality of articulated linkages, which serve as the mechanical backbone of the finger actuation structure 11. The plurality of linkages can be designed to mimic the natural articulation of the human finger, allowing for a wide range of movement and to provide a degree of flexibility and relief to the user's finger.

In embodiments, the finger actuation structure 10 can further comprise a plurality of actuators. The actuators are responsible for driving the movement of the linkages, and by extension, the user's finger. The plurality of actuators can be coupled to the plurality of articulated linkages such as for example a first actuator 44 can be coupled to a first articulated linkage 13, a second actuator 42 can be coupled to a second articulating linkage 14, and a third actuator 40 can be coupled to a third articulating linkage 16. Each of the articulated linkages are selectively and operatively coupled to at least one actuator. The plurality of actuators can be such as, for example, drive motor, servo motor, stepper motor, DC motor, AC motor, or the like. These types of actuators are known for their precision and reliability, making them an ideal choice for this application. The articulating linkages can be such as, for example, z-shaped, spring shaped, straight, cantilevered or the like, and can allow for relief and avoid excess force or pressure on the user's fingers and skin as the device bends each joint. The plurality of actuators and plurality of articulating linkages can be placed on the top of the user's fingers or the side of the user's fingers and can bend the user's finger at each finger joint.

The thumb structure 51 can have a thumb tip actuator 52 and a base thumb actuator 50 wherein the thumb tip actuator can be coupled to a thumb tip articulated linkage 56 and the base thumb actuator can be coupled to a base articulated linkage 59. The thumb tip actuator 52 shaft can rotate the thumb tip articulated linkage 54 and the base thumb actuator 50 shaft can be rotatably coupled to the thumb base articulated linkage 56 creating a joint. The base thumb actuator 50 can be coupled to the base articulated linkage 59 which can be coupled to a thumb base 58. The device can have a plurality of joints wherein each articulated linkage can be coupled together by the actuator shaft creating a joint between each articulated linkage. The joints 86 can be the shaft of the actuators and can be located close to or at each joint of the user's fingers, wherein each shaft of the actuator can connect to the adjacent linkage. The joints are designed to allow relative movement between the adjacent linkages, further enhancing the system's ability to mimic the natural movement of the human finger. The joints are a critical component of the system, as they allow for the precise articulation of the linkages. The actuators and joints can provide a direct and precise means of controlling finger movement, which can allow for a degree of give and comfort, reducing the risk of injury or discomfort to the user.

In embodiments the device 10 can further comprise a control unit 80 can be such as, for example, a microcontroller, a controller, Proportional-Integral-Derivative (PID) Controller, Deep Neural Network (DNN) Controller, Adaptive Controller, K210 Control Board or the like. coupled to a plurality of sensors wherein the control unit is a critical component of the system, as it is responsible for controlling the operation of the actuators. The control unit 80 can be configured to receive input signals of a desired finger movement wherein these signals can be generated in a variety of ways, such as through a user interface or through a pre-programmed sequence. Based on these input signals, the control unit 80 generates control signals which are sent to the at least one actuator. The actuators then move the linkages in accordance with these control signals, resulting in the desired finger movement. The sensors can be configured to detect various parameters related to such as, for example, location, motion, force, position, or the like of the user's finger. This information can be used to provide feedback to the control unit, allowing for real-time adjustments to the control signals wherein the feedback loop ensures that the system is able to accurately achieve the desired finger movement, even if the initial input signals are not perfect. The articulated linkages can be such as, for example, servo linkages, relieve linkages, or the like.

The plurality of sensors 30 can be coupled to the third ring 24 and thumb tip ring 28 and in other embodiment the plurality of sensors can be coupled to at least one of the one or more finger rings. The plurality of sensors 30 can be such as, for example, force sensitive resistors (“FSR”) sensors, inertial measurement unit (“IMU”) sensors, or the like which can measure and send information to the control unit on the specific force, angular rate, and orientation of the user's fingers and thumb. The FSR sensor 82 can be coupled to the third ring 24 and thumb tip ring 28 and the rings at the phalanxes measuring pressure force date and sending the information to the controller 80. The IMU sensor 84 can be coupled to at least one of the rings including the third ring 24 and thumb tip ring 28 measuring the acceleration, force, angular rate and orientation of the user's fingers and thumb. The information collected by the FSR sensor 82 and the IMU sensor 84 is sent to the control unit 80.

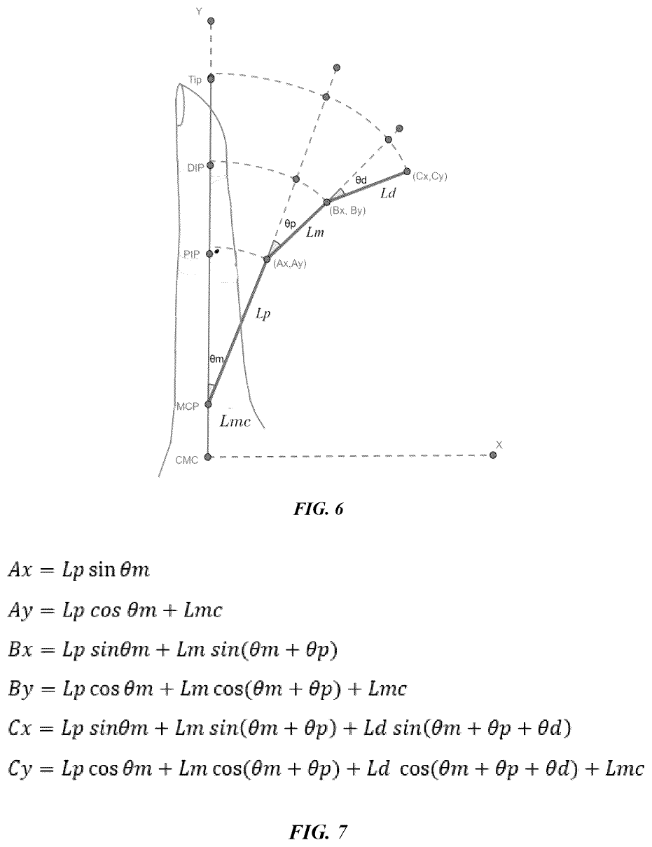

The control unit 80 can process a position analysis for the finger to determine the position of all the links in the finger actuation structure. The analysis employs a geometric method, as shown in FIG. 6, which illustrates the index finger kinematic model. Lmc, Lp, Lm, and Ld represent the lengths of the links for the Index (Second) Metacarpal, Index Proximal Phalanx, Index Middle Phalanx, and Index Distal Phalanx. θm, θp, and θd denote the rotating angles of the joints on the Index MCP, PIP, and DIP. The position coordinates of the Index PIP joint, Index DIP joint, and fingertip after the movements are represented by (Ax, Ay), (Bx, By), and (Cx, Cy). The positions of the index PIP joint, Index DIP joint and fingertip are determined by the equations shown in FIG. 7.

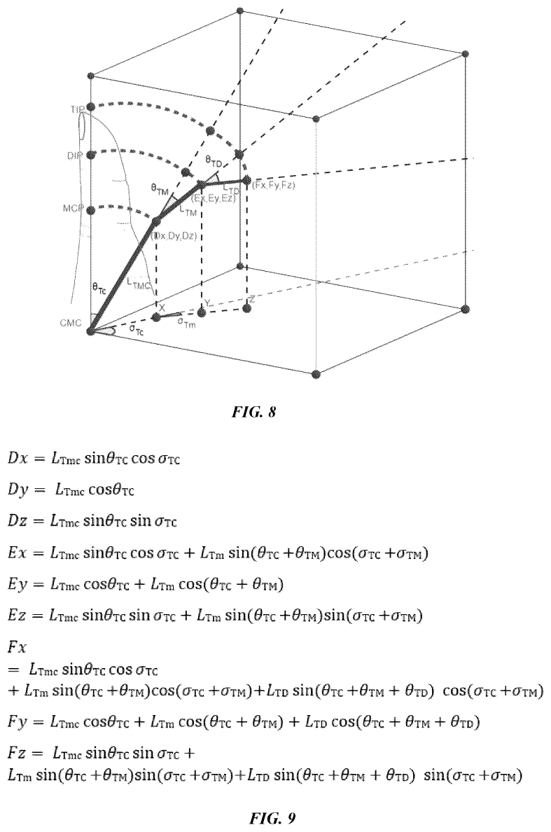

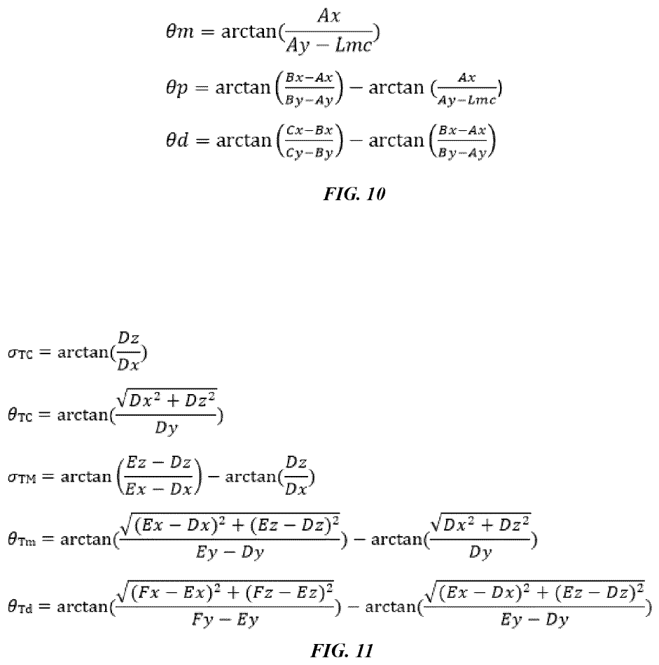

The control unit 80 can process a position analysis for the thumb to determine the position of all the links in the finger actuation structure. FIG. 8 shows the thumb kinematic model. Ltmc, Ltm, and Ltd represent the lengths of the links for the First Metacarpal, First Proximal Phalanx, and First Distal Phalanx of the thumb. θtc, θtm, and θtd denotes the rotating angles of the joints on Thumb CMC, Thumb MCP, and Thumb DIP. δtc represents the shifting angle of the First Metacarpal plane from the initial plane, and δtm represents the shifting angle of the First Proximal Phalanx/First Distal Phalanx plane from the First Metacarpal plane. The position coordinates of the Thumb MCP joint, DIP joint, and fingertip after the movements are represented by (Dx, Dy), (Ex, Ey), and (Fx, Fy). The positions of the thumb MCP joint, DIP joint and thumb tip are determined by the equation shown in FIG. 9. To determine the orientation and angles of each linkage on the finger and the thumb inverse kinematics is used as shown in FIG. 10 for the index finger and FIG. 11 for the thumb.

In embodiments, a servo linkage 32 can be coupled to a thumb base 58 wherein the servo linkage can be coupled to a servo linkage actuator 46 allowing the user's finger to be bent at the base. The servo linkage 32 can be such as, for example, pushrod linkage, turnbuckles camber linkage, cable or wire linkage, linear actuator linkage, scissor linkage, parallel linkage, or the like. The thumb base 58 can be coupled to the user's wrist by at least one strap 34 wherein the strap can be such as, for example, neoprene, hook and loop, nylon, polyester, webbing, elastic, or the like.

The finger actuation structure 10 can further comprise a mechanical switch 102 coupled to the control unit 80, an artificial voice control with microphone 106 coupled to the control unit and a speaker 104 coupled to the control unit. The mechanical switch 102 can allow the user to input command numbers for running pre-programmed protocols for the device 10 which can also allow a third-party run protocols for patients. The mechanical switch 102 can be such as, for example, 4-row by 4-column keypad, matrix keypad, touchpad, or the like. The AI voice recognition control can be implemented for patients with impaired hands who utilize voice commands to interact with the system during treatment. Pre-programmed treatment protocols and communication processes are established based on voice commands.

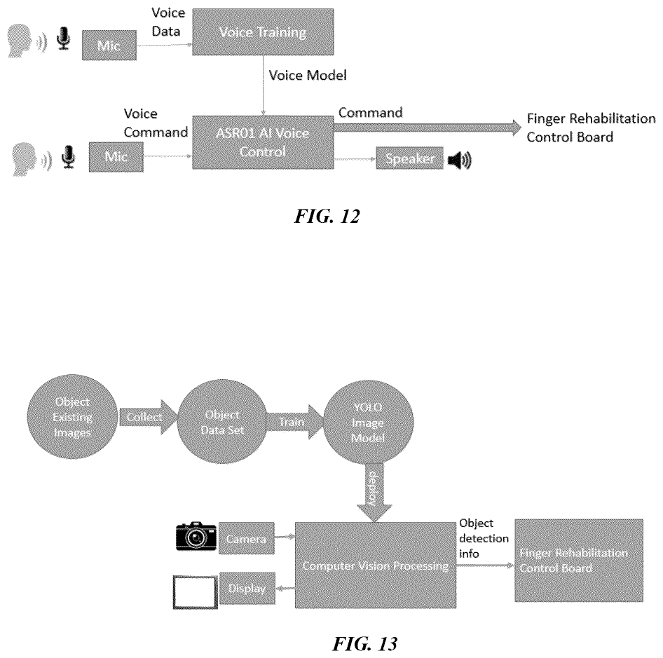

The AI voice control system can collect and train the patient's voices to detect and recognize valid commands as shown in FIG. 12. The automatic speech recognition (“ASR”) can enable the control unit to transcribe spoken language into text which can involve processing audio input, identifying speech patterns, and converting them into textual form. The ASR can utilize various techniques, such as Hidden Markov Models (HMMs) or deep learning approaches like Recurrent Neural Networks (RNNs) and Convolutional Neural Networks (CNNs). The AI voice control can understand natural language understanding (NLU) to interpret user commands or queries in a contextually relevant manner wherein machine learning can extract the meaning from the recognized text and generate a response or action based on the user input and send to the command to the device's control unit 80.

As shown in FIG. 13, the system 10 can have a computer vision control with machine learning which can be implemented for object detection and preliminary autonomous grasping. For example, when a command is given to grasp an object, the finger actuation structure requires precise timing to drive the actuator for the grasp operation wherein the operation is executed only when the object is detected and properly positioned. Additionally, a You Only Look Once (“YOLO”) machine learning can be employed in the computer vision method. The YOLO, known as a one-stage Convolutional Neural Network (“CNN”) algorithm, which can excel in fast and unified real-time object detection, making it an ideal choice for the finger rehabilitation detection task that demands rapid categorization and location determination, however other machine learning algorithms can be implemented in its place. YOLO can treat a task as a single regression problem that can simultaneously predict bounding boxes and class probabilities for multiple objects within an input image. This network can take the entire image as an input and directly output a set of bounding boxes along with their corresponding class probabilities.

The control unit 80 which can be equipped with an integrated camera and display screen which can execute the computer vision task with machine learning. Utilizing a Canaan developer platform, existing images can be curated into object datasets, which can be subsequently trained using the YOLO one-stage CNN algorithm to create the YOLO image model. Once deployed on the control unit 80 which can be a K210 control board, the model efficiently detects objects from images captured by the camera, with the detection block prominently displayed on the screen. The Canaan developer platform can mine for the image and then can create an object dataset.

The system 10 can execute the grasp operation by determining the optimal timing to grasp an object. Using computer vision the object can be identified and the distance from the object can be calculated. Once the object is detected, the coordinate positions of the detection block are transmitted to the control unit 80. The control unit 80 can assess the distance between the finger actuation structure and the object, utilizing the size of the detected object. If the distance suggests that the finger actuation structure is in close proximity to the object, the grasping operation is promptly executed or if the distance is too far the grasping function is held until the object is close enough to grasp.

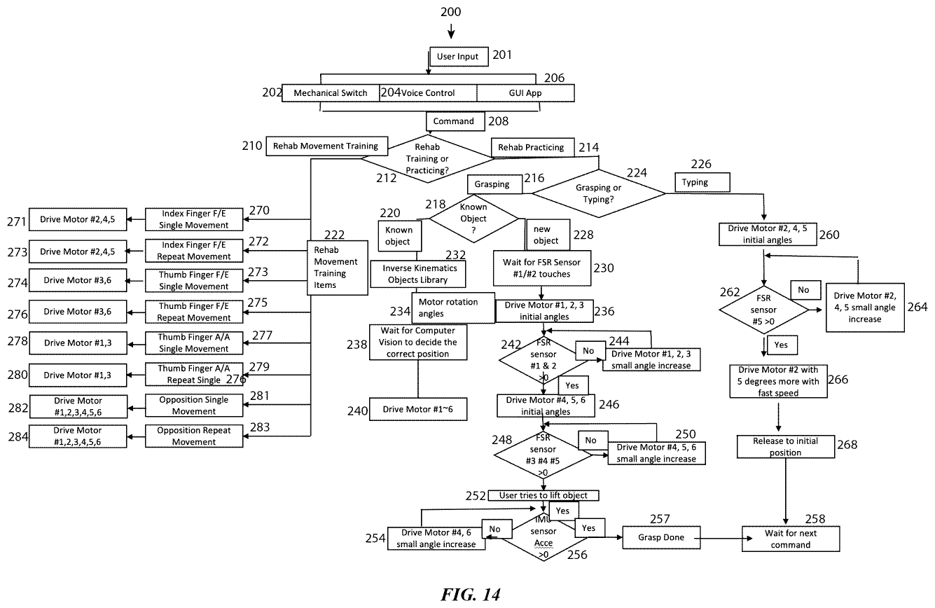

Referring to FIG. 14, a method for controlling a rehabilitation device at 200. The method 100 can comprise a user input 201 through a mechanical switch 202, voice control 204, and/or GUI application 206 on a smart phone or tablet which can send a command 208. The command 208 can be at least one of the following tasks, rehab movement training 210, rehab training or practicing 212, and/or rehab practicing. If rehab movement training 210 a set of rehab movement training items 22 are cycled through wherein the process comprises moving the index finger 270 and activating at least one drive motor 271 wherein the drive motor can be the at least one actuator of the system 10 in FIG. 1. Repeating the index finger movement 272 and activating at least one drive motor 273. Moving the thumb finger in a single movement 273 and activating at least one drive motor 273. Repeating the thumb movement 275 and activating at least one drive motor 276. Moving the thumb in a single movement 277 and activating at least one drive motor 278. Repeating the thumb in a single movement 279 and activating at least one drive motor 280. Moving opposition single movement 281 and activating at least one drive motor 282. Repeating opposition single movement 283 and activating at least one drive motor 284.

At 214, practicing rehab wherein the user can choose, or the control unit can cycle through grasping or typing command. At 216, grasping a known object 218 or a new object 228 wherein if the object is known 220 within a library of objects, then inverse kinematics is used to determine the object. Inverse kinematic can determine the joint configurations of a robotic manipulator or a mechanical system required to achieve a desired end-effect or position and orientation. Unlike forward kinematics, which calculates the position and orientation of the end-effector based on the joint angles, inverse kinematics works in the opposite direction, determining the joint angles necessary to achieve a specific end-effector pose. By determining what the object is the desired position and orientation of the end-effector can be calculated using coordinates in a Cartesian space or other appropriate coordinate systems. Using the known geometric and kinematic constraints of the system, the inverse kinematics problem is formulated. This involves determining the relationship between the joint angles and the end-effector pose. In some cases, an initial solution obtained from solving the inverse kinematics equations may not fully satisfy all constraints, such as joint limits or obstacle avoidance. In such cases, iterative refinement techniques may be employed to adjust the joint angles gradually until a satisfactory solution is achieved. By using inverse kinematics, the rehabilitation device 10 angles can be determined, and motor/actuator travel distance can be set 234. At 238, waiting for computer vision to determine the contact position of the object. At step 240, moving the drive motor to the desired position.

At 228, detecting a new object and waiting for the FSR sensors to touch the object 230. The FSR can be made from a polymer material that has conductive properties. This polymer can be typically sandwiched between two conductive layers, forming a simple circuit. When no force is applied, the resistance of the sensor is relatively high due to the gaps between the conductive particles. When force is applied, these particles come into closer contact, reducing the resistance of the sensor. At 236, activating the drive motor initial angles. Sensing the objects with the at least one FSR sensor 242 for the thumb structure, wherein if the object is touched then the initial angles for the drive motor is set 246, if the object is not detected then the drive motor increases in small angles 244 until the object is sensed. At 248, activating at least one FSR sensors for the index structure wherein at 250 if the object is not detected the motor increases the angle in small increments, at 250. At 252, attempting to lift the object wherein if the IMU sensor measure acceleration, at 256, within the device 10. At step 254 if the object is not lifting then the motor can increase in small angles, if the object is lifted then the grasp is complete 257.

At 226, typing is chosen then imitating the motors and setting the initial angles 260. At least one FSR sensor detects the keyboard keys at 262, and if not detected the motor moves in small angles until the keyboard is detected, at 264. At 266, increasing speed of drive motor of at least 5 degrees wherein once the keyboard is contacted, at 268, releasing to the initial position and the device then waits for the next command, at 258.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

I claim:

1. A finger actuation structure for use with at least one finger comprising:
one or more finger rings configured to encircle at least one finger of a user, wherein the one or more finger rings are coupled to a plurality of articulated linkages;
a plurality of actuators wherein each actuator is operatively coupled to at least one linkage of the plurality of articulated linkages;
a control unit configured to receive input signals of a desired finger movement and to generate control signals for controlling the plurality of actuators based on the received input signals; and
a plurality of joints wherein each joint connects adjacent linkages of the plurality of articulated linkages, wherein each joint is configured to allow relative movement between the adjacent linkage.

2. The finger actuation structure of claim 1, wherein the one or more finger rings has at least one sensor wherein the at least one sensor is a force sensitive resistor or an inertial measurement unit sensor.

3. The finger actuation structure of claim 1, wherein the plurality of actuators is a servo motor.

4. The finger actuation structure of claim 1, wherein the plurality of articulated linkages is at least of one of a servo linkage or a relieve linkage.

5. The finger actuation structure of claim 2, wherein the at least one sensor is configured to detect location, motion, force and/or position of the at least one finger of the user.

6. The finger actuation structure of claim 2, wherein a feedback loop connects the plurality of sensors to the control unit, wherein the control unit adjusts the control signals based on the sensor signals to achieve a desired finger movement.

7. The finger actuation structure of claim 4, wherein the relieve linkage is z-shape made of a flexible material.

8. The finger actuation structure of claim 1, further comprising a computer vision coupled to the control unit.

9. A method for controlling a finger actuation structure of claim 1 comprising:
inputting at least one command from a user;
running the command through a set of operations;
activating at least one actuator from the set of operations from the command from the user;
moving an index finger and/or a thumb finger by at least one actuator; and
sensing the position of the index finger and/or thumb position and adjusting the actuators according to the user's command.

10. The method for controlling the finger actuation structure of claim 9 wherein the command is at least one of rehab movement training, and/or rehab practicing.

11. The method for controlling the finger actuation structure of claim 10 wherein rehab movement training comprises moving the index finger and the thumb finger in a single movement and a repeat movement by activating at least one actuator.

12. The method for controlling the finger actuation structure of claim 10 wherein rehab practicing comprises grasping an item and/or typing.

13. The method for controlling the finger actuation structure of claim 12 recognizing a known or unknown item wherein if the item is known the index finger or thumb finger moves to the known item's position.

14. The method for controlling the finger actuation structure of claim 12 wherein typing includes setting the actuators to an initial angle and sensing a keyboard wherein if the keyboard is sensed then the actuators move and release the fingers or increase the angle until the keyboard is sensed.
